(19) United States
(12) Patent Application Publication
(10) Pub. No.: US 2011/0147025 A1
(43) Pub. Date: Jun. 23, 2011

(54) Power tool having an impact mechanism

(76) Inventors: Peng Eng Lin, Alor Star Kedah (MY); Sim Teik Yeoh, Gelugor Penang (MY); Chuan Cheong Yew, Penang (MY)

(21) Appl. No.: 12/926,877

(22) Filed: Dec. 15, 2010

(30) Foreign Application Priority Data
Dec. 15, 2009 (EP) 09179157.4

(51) Int. Cl. B25B 21/02

(52) U.S. Cl. 173/112

(57) ABSTRACT

A power tool having an impact mechanism including a rotary shaft defining a tool axis of rotation, an impact member moveable along the tool axis of rotation, a support member fixed in position relative to the tool axis of rotation, a biasing member for urging the impact member away from the support member, and at least one axial stop member positioned between the impact member and the support member. According to the invention, the distance between the axial stop member and the tool axis of rotation is more than the distance between the biasing member and the tool axis of rotation.

### CROSS-REFERENCE TO RELATED APPLICATION

This application is based on European Patent Application 09179157.4 filed on Dec. 15, 2009.

### BACKGROUND OF THE INVENTION

1. Field of the Invention

The present invention relates to hand-held rotary power tools. In particular it relates to an impact mechanism for an impact driving tool which includes means for restricting the travel of the impact member. In such tools, assembly may be facilitated by designing them so that the balls used in coupling the impact member to the rotary shaft can be inserted by displacing the impact member against the force of a spring by a distance that is greater than the impact member would normally be displaced when the power tool is operating. However, such a configuration runs the risk that the coupling balls will escape under extreme conditions, such as when the tool is dropped, thereby creating a non-functioning tool that would require repair or replacement by the user. Such an extreme condition can also damage the tool in other ways, for example if the impact member were to strike other more delicate elements within the power train.

2. Description of the Prior Art

JP 3780831 B2 describes an impact driver incorporating a ring-shaped elastic body that surrounds the rotating shaft and limits travel of the impact member. Since the diameter of the elastic body is less than that of the coil spring that biases the impact member, it is seated fully within the spring. The elastic body is retained in a fixed position by a retaining element biased by this spring. This arrangement has the disadvantage that when the striker contacts the elastic element, there is a potential for damage to tool components positioned near the shaft. Furthermore such a configuration may also lengthen the power train, thereby undesirably limiting the compactness of the power tool.

### ADVANTAGES AND SUMMARY OF THE INVENTION

A power tool having an impact mechanism is described as having a rotary shaft defining a tool axis of rotation, an impact member moveable along said axis of rotation, a support member fixed in position relative to said tool axis of rotation, a biasing member for urging the impact member away from said support member, and at least one axial stop member positioned between the impact member and the support member, wherein the distance between the axial stop member and the tool axis of rotation is more than the distance between the biasing member and the tool axis of rotation. This arrangement ensures that the axial stop member will not interfere with other components used for stabilizing the rotary shaft, such as ball bearings or friction bearings. Advantageously, the axial stop member will stop the impact member from damaging any such components during extreme conditions, such as when dropping the tool. Furthermore, by positioning the axial stop member peripherally, it can coexist in the same axial space as other tool components, such as ball bearings, so that the tool can maintain a relatively shorter power train and/or use this same space to optimize other components for improved performance.

If the axial stop member is flexible, this permits the incorporation of the coupling balls into the tool according to an existing practice. For example, when the impact member is caused to move against the force of the spring via a slow-acting force, the axial stop member may be caused to flex, thereby allowing insertion of the coupling balls. Nevertheless a quick-acting force that might occur when dropping the tool might also not cause the axial stop member to flex significantly.

It is advantageous if the axial stop member is arc-shaped since it would then conform with the shape of impact member and therefore can better act on the impact member in a uniform way. Ideally a plurality of axial stop members is provided, each one shaped in this way, so that any load coming from the impact member would be distributed among several axial stop members.

In order to better position the axial stop member and retain it in place during assembly of the tool and furthermore after tool assembly, the axial stop member can be formed so that it extends axially from a positioning member. If such a positioning member is provided with radial protrusions, these can be used as means for restricting movement of the positioning member, so that each axial stop member is retained in place.

To further cause the positioning member to be retained both during and after assembly, a retaining member may be provided. This has the advantage that the axial stop member does not move into variable positions, some of which might alter the performance of the tool during normal use via interference with the impact member. Such a retaining member may also be useful during assembly.

When the inner diameter of the retaining member is less than the outer diameter of the spring, those portions of the retaining member that are within the diameter of the spring can be used to retain other elements such as ball bearings or friction bearings used to stabilize the rotating shaft. If the outer diameter of the retaining member is greater than outer diameter of the spring, the spring itself can be advantageously used to bias the retaining member to keep it in place.

So that the retaining member is kept in a fixed position, it can in a manner similar to the positioning member be advantageously provided with radial protrusions that via interaction with aspects of the tool housing may restrict movement of the retaining member.

The rotary tool may be provided with one or more ball bearings for stabilizing the rotary shaft. If this is the case, it is desirable for the axial stop member to be located radially relative to the ball bearing, so that there is no damage to the ball bearing upon impact from the impact member. Furthermore, such a configuration adds to the compactness of the design. As such it is advantageous if the at least one ball bearing and the at least one axial stop member fall together within at least one plane that is perpendicular to the tool axis of rotation.

The impact member may have a distal axial length that is longer than its proximal axial length. This arrangement creates more space in the area near the drive shaft, so that ball bearings and the like can be accommodated while still maintaining a compact power train.

### BRIEF DESCRIPTION OF THE DRAWINGS

The invention will be better understood and further objects and advantages thereof will become more apparent from the ensuing detailed description of the preferred embodiment taken in conjunction with the drawings, in which:

FIG. 1 is a section view an impact driver according to the present invention;

FIG. 2 is perspective view of the positioning ring; and

FIG. 3 is a perspective view of the impact assembly and gear box wherein the impact assembly housing has been removed.

### DESCRIPTION OF THE PREFERRED EMBODIMENT

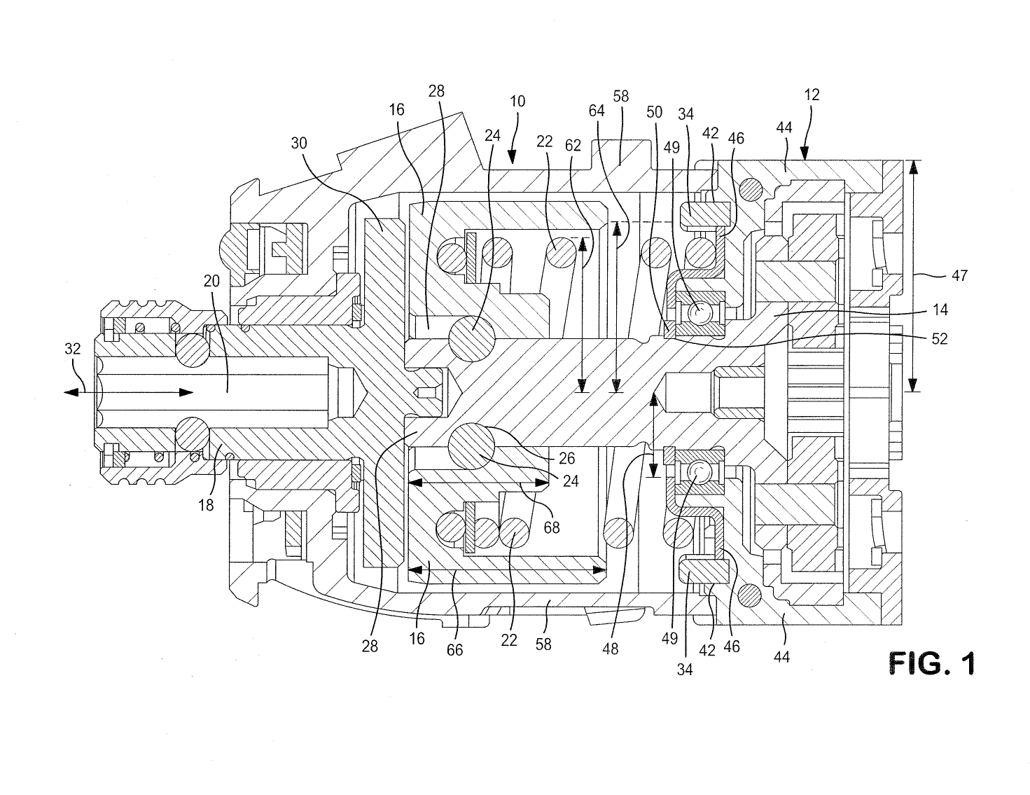

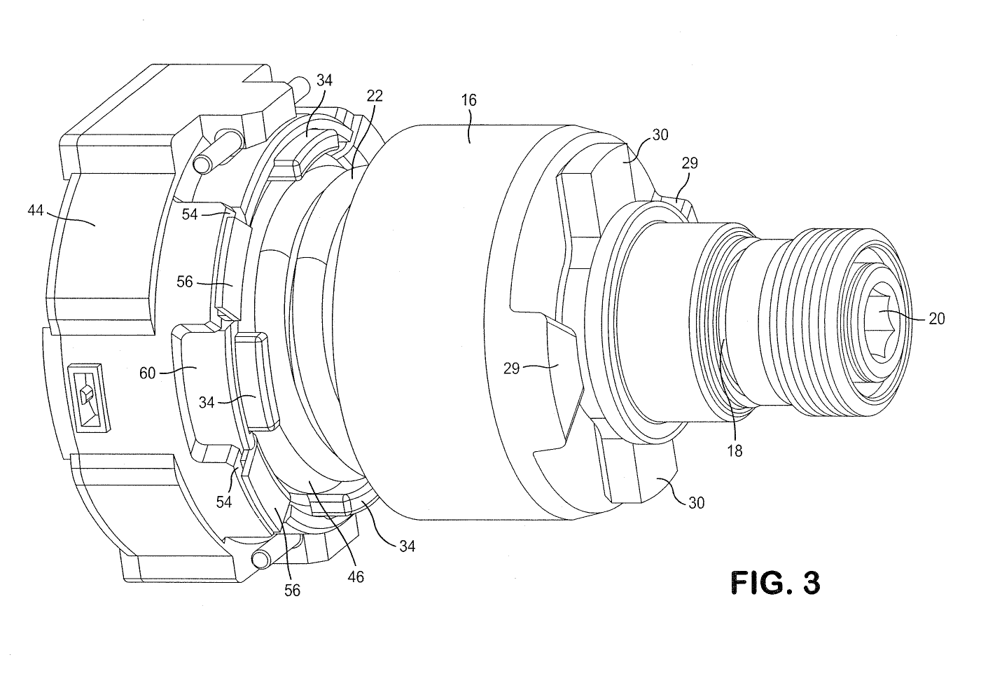

The impact assembly 10 and gear box 12 of a hand-held power tool are shown in FIG. 1. Rotary output exiting gear box 12 via a driveshaft 14 is transmitted via a coupling with a striker 16 to an output shaft 18. When there is little load on a tool inserted into cavity 20 in output shaft 16, a spring 22 acts as a biasing member for urging striker 16 into contact with output shaft 18 so that the tool is rotated. However driveshaft 14 is coupled to striker 16 in a manner that permits striker 16 to rotate as well as move axially with respect to driveshaft 14. The coupling is mediated by balls 24 that are seated partially within a grooved surfaces 26 in drive shaft 14 and partially within cavities 28 in striker 16. This allows striker 16 to act as an impact member under higher load conditions by moving against the force of spring 22 and ultimately delivering an impact with each of its two protrusions 29 to each of the two anvil arms 30 of output shaft 18 (see FIG. 3). Further details of the impact mechanism are not provided since impact assembly 10 is typical of impact driving tools and the functioning of its principle components is well understood by those skilled who are in the art.

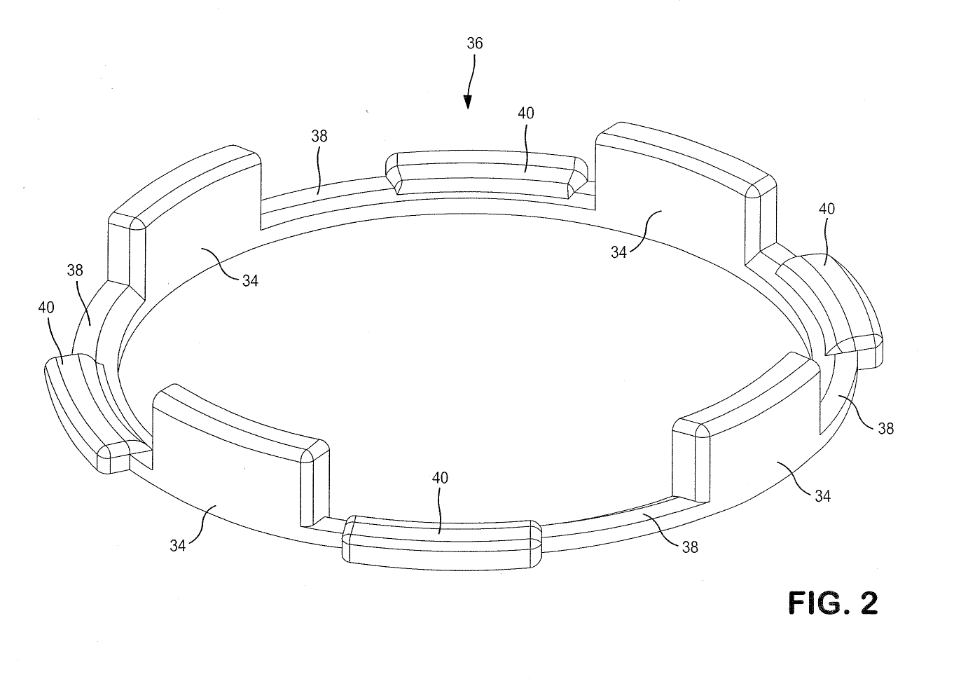

The axial travel of striker 16 along tool axis of rotation 32 is limited by arc-shaped axial stop members 34 that extend from a positioning ring 36 which acts as a positioning member (see FIG. 2). Positioning ring 36 as well as the axial stop members 34 found thereon are preferably formed of a flexible, elastomeric material such as rubber or plastic or any of a variety of elastic polymers. As such, axial stop members 34 provide a dampening function when they are contacted by striker 16, absorbing some of the force of the striker and limiting damage to downstream components. At the same time, they restrict translational movement of striker 16, particularly when striker 16 moves suddenly, such as when the tool has been dropped, without restricting movement of striker 16 absolutely.

As shown, preferably four axial stop members 34 are provided, but at least two, and potentially three, five, six, or even more than six members may be provided. Axial stop members 34 should preferably be symmetrically arranged about positioning ring 36. Non-symmetrical arrangements including one or more such axial stop members 34 are also contemplated, but bear the possible risk of damage and/or uneven wear to the tool due to the asymmetry. Axial stop members 34 do not need to be arc-shaped, although this is preferable, since striker 16 is cylindrical and therefore arc-shaped at its periphery.

Depending on design considerations, such as the dimensions of the striker, the axial length of axial stop members 34 may be conveniently adjusted to be longer or shorter than as shown in the representative embodiment. Ideally the length of the axial stop members 34 is chosen in a manner that provides enough clearance so that striker 16 will never hit axial stop members 34 during normal operation of the tool.

Positioning ring 36 has a ring-shaped ring main portion 38 from which axial stop members 34 and radial protrusions 40 extend. Radial protrusions 40 may be arranged as shown in FIG. 2 to have only partial symmetry about axis of rotation 32, thereby limiting the orientations in which positioning ring 36 may be assembled into the power tool. An annular cavity 42 is provided in gear box housing 44 as a seat for receiving ring main portion 38. Positioning ring 36 is retained in its seated position by a retaining plate 46 which is biased in the direction of gear box housing 44 by spring 22 (see FIG. 3). Retaining plate 46 has an outer diameter 47 and an inner diameter 48.

Spring 22 is positioned between striker 16 and a portion of gear box housing 44 that extends from the periphery of gear box housing 44 towards tool axis of rotation 32. Hence this portion of gear box housing 44 serves as a support member for spring 22 which in turn urges this striker 16 away from gear box housing 44. In the illustrated example, gear box housing 44 also provides annular cavity 42 so that it also serves as a support member with respect to the positioning member and any axial stop members 34 positioned thereon. As is the case with spring 22, axial stop members are positioned between the support member and the impact member. Axial stop members 34 are however positioned outside of spring 22 (i.e., positioned radially with respect to spring 22). Different support members such as other housing portions that are not directly associated with the gear box are also contemplated, so long as they present a surface for supporting spring 22 which stays fixed in position relative to tool axis of rotation 32.

Ball bearings 49 for stabilizing driveshaft 14 are also fixed against gear box housing 44 by retaining plate 46 but also by a C-ring 50 that is received in an annular groove 52 on driveshaft 14 (see FIG. 1). It is significant that these bearing members are located generally at the same point along the tool axis of rotation 32 as axial stop members 34. In other words, ball bearings 49 and axial stop members 34 fall together within at least one plane that is perpendicular to tool axis of rotation 32. In order to achieve the most compact impact mechanism design, it is preferable if the axial stop members 34 are positioned directly radial from ball bearings 49, so that they completely overlap in position.

Radial protrusions 40 extend into correspondingly-shaped indentations 54 along the perimeter of the gear box housing 44. This serves to prevent rotation of positioning ring 36 once it has been seated in gear box housing 44 during assembly. Rotation of positioning ring 36 is also hindered by corresponding retaining plate protrusions 56. During assembly of the tool, these protrusions 56 are further kept in place by an impact assembly housing 58 which generally mates with gear box housing 44 and has extensions (not shown) which are received in paired recesses 60 in the perimeter of gear box housing 44.

The above retaining features may be used to retain axial stop members 34 in position even for alternative constructions. For example, in one alternative, positioning ring 36 may be replaced by an alternative arc-shaped positioning member that includes just one protrusion 40 and one axial stop member 34. Other non-ring shaped positioning members are contemplated comprising one or more protrusions 40 paired with one or more axial stop members 34. Protrusions are not necessarily present, as a positioning member having multiple axial stop members could also be retained in position by retaining plate 46 as well as retaining members having other configurations. Neither the positioning member nor the axial stop members need to be arc-shaped in order to function for this purpose. They can, for example be linear or irregular in shape, so long as there is a mechanism provided for securing the positioning member in a particular position.

The entirety of positioning ring 36 including its axial stop members 34 and radial protrusions 40 is located outside of spring 22. In other words, the distance 62 from tool axis of rotation 32 to the radially outermost aspects of spring 22 is less than the distance 64 from tool axis of rotation 32 to the radial innermost aspects of positioning ring 36.

In some cases, it may be preferable for the distal axial length 66 of striker 16 to be longer than the proximal axial length 68. For example, as seen in FIG. 1, if axial stop member 34 is shorter than the combined axial length of ball bearing 48 and retaining plate 46, then a striker not having this length differential would contact retaining plate 46 before contacting axial stop member 34. If axial stop member 34 were longer, this condition need not be fulfilled, but such a change would have a net effect of lengthening the impact assembly.

The foregoing relates to the preferred exemplary embodiment of the invention, it being understood that other variants and embodiments thereof are possible within the spirit and scope of the invention, the latter being defined by the appended claims.

We claim:

1. A power tool having an impact mechanism, comprising:
a rotary shaft defining a tool axis of rotation;
an impact member moveable along the tool axis of rotation;
a support member fixed in position relative to the tool axis of rotation;
a biasing member for urging the impact member away from the support member;
at least one axial stop member positioned between the impact member and the support member, wherein
a distance between the axial stop member and the tool axis of rotation is more than a distance between the biasing member and the tool axis of rotation.

2. A power tool according to claim 1, wherein the axial stop member is flexible.

3. A power tool according to claim 1, wherein the axial stop member is arc-shaped.

4. A power tool according to claim 2, wherein the axial stop member is arc-shaped.

5. A power tool according to claim 1, wherein the axial stop member extends axially from a positioning member.

6. A power tool according to claim 2, wherein the axial stop member extends axially from a positioning member.

7. A power tool according to claim 3, wherein the axial stop member extends axially from a positioning member.

8. A power tool according to claim 4, wherein the axial stop member extends axially from a positioning member.

9. A power tool according to claim 5, wherein the positioning member has radial protrusions for restricting movement of the positioning member.

10. A power tool according to claim 6, wherein the positioning member has radial protrusions for restricting movement of the positioning member.

11. A power tool according to claim 7, wherein the positioning member has radial protrusions for restricting movement of the positioning member.

12. A power tool according to claim 8, wherein the positioning member has radial protrusions for restricting movement of the positioning member.

13. A power tool according to claim 5, wherein a retaining member is provided for retaining the positioning member.

14. A power tool according to claim 9, wherein a retaining member is provided for retaining the positioning member.

15. A power tool according to claim 13, wherein an inner diameter of the retaining member is less than an outer diameter of the biasing member.

16. A power tool according to claim 14, wherein an inner diameter of the retaining member is less than an outer diameter of the biasing member.

17. A power tool according to claim 1, wherein the impact member has a distal axial length and a proximal axial length and the distal axial length is longer than the proximal axial length.

18. A power tool according to claim 1, further comprising at least one ball bearing for stabilizing the rotary shaft, wherein the at least one ball bearing and the at least one axial stop member fall together within at least one plane that is perpendicular to the tool axis of rotation.

19. A power tool according to claim 18, wherein the at least one axial stop member and the at least one ball bearing have substantially a same position along the axis of rotation.

20. A power tool according to claim 1, further comprising a plurality of axial stop members.
